(19) United States
(12) Patent Application Publication
(10) Pub. No.: US 2024/0314798 A1
(43) Pub. Date: Sep. 19, 2024

(54) DCI-BASED INDICATION TO TRIGGER THE COMBINED ML MODEL

(71) Applicant: QUALCOMM Incorporated, San Diego, CA (US)

(72) Inventors: Yuwei REN, Beijing (CN); Huilin XU, Temecula, CA (US); June NAMGOONG, San Diego, CA (US)

(21) Appl. No.: 18/571,053

(22) PCT Filed: Aug. 10, 2021
(86) PCT No.: PCT/CN2021/111692

§ 371 Date: Dec. 15, 2023

(51) Int. Cl. H04W 72/231; H04W 24/02; H04W 76/20

(52) U.S. Cl. CPC H04W 72/231; H04W 24/02; H04W 76/20

(57) ABSTRACT

A base station may set one or more bits of DCI that at least one of indicate or trigger a configuration of an ML model at a UE. The configuration may be based on an association between at least one first ML block for a first procedure and at least one second ML block for a second procedure. The at least one second ML block may be dedicated to a task included in a plurality of tasks associated with the at least one first ML block. The base station may transmit the DCI including the one or more bits to the UE, which may cause the UE to configure the ML model including the association between the at least one first ML block for the first procedure and the at least one second ML block for the second procedure.

### INTRODUCTION

The present disclosure relates generally to communication systems, and more particularly, to configuring a machine learning (ML) model.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communication (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method includes receiving downlink control information (DCI) for at least one of triggering or determining a configuration of a machine learning (ML) model, the configuration of the ML model based on an association between at least one first ML block for a first procedure and at least one second ML block for a second procedure, the at least one second ML block dedicated to a task included in a plurality of tasks associated with the at least one first ML block; and configuring the ML model including the association between the at least one first ML block for the first procedure and the at least one second ML block for the second procedure based on the DCI for at least one of triggering or determining the configuration of the ML model.

In another aspect of the disclosure, an apparatus for wireless communication at a UE is provided. The apparatus includes means for receiving DCI for at least one of triggering or determining a configuration of an ML model, the configuration of the ML model based on an association between at least one first ML block for a first procedure and at least one second ML block for a second procedure, the at least one second ML block dedicated to a task included in a plurality of tasks associated with the at least one first ML block; and means for configuring the ML model including the association between the at least one first ML block for the first procedure and the at least one second ML block for the second procedure based on the DCI for at least one of triggering or determining the configuration of the ML model.

In another aspect of the disclosure, an apparatus for wireless communication at a UE is provided. The apparatus includes memory and at least one processor coupled to the memory, the memory and the at least one processor configured to receive DCI for at least one of triggering or determining a configuration of an ML model, the configuration of the ML model based on an association between at least one first ML block for a first procedure and at least one second ML block for a second procedure, the at least one second ML block dedicated to a task included in a plurality of tasks associated with the at least one first ML block; and configure the ML model including the association between the at least one first ML block for the first procedure and the at least one second ML block for the second procedure based on the DCI for at least one of triggering or determining the configuration of the ML model.

In another aspect of the disclosure, a non-transitory computer-readable storage medium at a UE, is provided. The non-transitory computer-readable storage medium is configured to receive DCI for at least one of triggering or determining a configuration of an ML model, the configuration of the ML model based on an association between at least one first ML block for a first procedure and at least one second ML block for a second procedure, the at least one second ML block dedicated to a task included in a plurality of tasks associated with the at least one first ML block; and configure the ML model including the association between the at least one first ML block for the first procedure and the at least one second ML block for the second procedure based on the DCI for at least one of triggering or determining the configuration of the ML model.

In another aspect of the disclosure, a method of wireless communication at a base station is provided. The method includes setting one or more bits of DCI that at least one of indicate or trigger a configuration of an ML model at a UE, the configuration of the ML model based on an association between at least one first ML block for a first procedure and at least one second ML block for a second procedure, the at least one second ML block dedicated to a task included in a plurality of tasks associated with the at least one first ML block; and transmitting the DCI that at least one of indicates or triggers the configuration of the ML model at the UE based on setting the one or more bits of the DCI.

In another aspect of the disclosure, an apparatus for wireless communication at a base station is provided. The apparatus includes means for setting one or more bits of DCI that at least one of indicate or trigger a configuration of an ML model at a UE, the configuration of the ML model based on an association between at least one first ML block for a first procedure and at least one second ML block for a second procedure, the at least one second ML block dedicated to a task included in a plurality of tasks associated with the at least one first ML block; and transmitting the DCI that at least one of indicates or triggers the configuration of the ML model at the UE based on setting the one or more bits of the DCI.

In another aspect of the disclosure, an apparatus for wireless communication at a base station is provided. The apparatus includes memory and at least one processor coupled to the memory, the memory and the at least one processor configured to set one or more bits of DCI that at least one of indicate or trigger a configuration of an ML model at a UE, the configuration of the ML model based on an association between at least one first ML block for a first procedure and at least one second ML block for a second procedure, the at least one second ML block dedicated to a task included in a plurality of tasks associated with the at least one first ML block; and transmit the DCI that at least one of indicates or triggers the configuration of the ML model at the UE based on setting the one or more bits of the DCI.

In another aspect of the disclosure, a non-transitory computer-readable storage medium at a base station, is provided. The non-transitory computer-readable storage medium is configured to set one or more bits of DCI that at least one of indicate or trigger a configuration of an ML model at a UE, the configuration of the ML model based on an association between at least one first ML block for a first procedure and at least one second ML block for a second procedure, the at least one second ML block dedicated to a task included in a plurality of tasks associated with the at least one first ML block; and transmit the DCI that at least one of indicates or triggers the configuration of the ML model at the UE based on setting the one or more bits of the DCI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates a diagram of a UE that includes a neural network configured for determining communications with a second device.

FIG. 5 is a call flow diagram illustrating communications between a UE and a network.

FIG. 6 is a diagram illustrating inputs and outputs for a plurality of combined machine learning (ML) models.

FIG. 7 is a call flow diagram illustrating communications between a UE and a network.

FIGS. 8A-8F illustrates bit sequence diagrams indicative of backbone blocks and specific/dedicated blocks for a combined ML model.

FIG. 9 is a call flow diagram illustrating communications between a UE and a base station.

FIG. 10 is a flowchart of a method of wireless communication at a UE.

FIG. 11 is a flowchart of a method of wireless communication at a UE.

FIG. 12 is a flowchart of a method of wireless communication at a base station.

FIG. 13 is a flowchart of a method of wireless communication at a base station.

FIG. 14 is a diagram illustrating an example of a hardware implementation for an example apparatus.

FIG. 15 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components (e.g., associated with a user equipment (UE) and/or a base station), end-user devices, etc. of varying sizes, shapes, and constitution.

Machine learning (ML) techniques may be based on one or more computer algorithms that are trained to automatically provide improved outputs for a processing operation based on stored training data and/or one or more prior executions. An ML model refers to an algorithm that is trained to recognize certain types of patterns, e.g., associated with the stored training data and/or the one or more prior executions, to learn/predict the improved outputs for the processing operation. ML models that are trained at a first device may be configured to a second device. For example, a network may transmit an ML model configuration to a UE to configure the UE with the ML model that was trained at the network, such that the UE may execute the ML model after receiving the ML model configuration from the network.

ML models may be used in wireless communication. Aspects presented herein include configuring a user equipment (UE) for a combined ML model via a downlink control information (DCI)-based indication. While the DCI-based indication may reduce a time for ML model configuration at the UE, physical downlink control channel (PDCCH) resources associated with the ML model configuration may be limited. Thus, implementations of DCI-based indications for configuring ML models at the UE may be balanced with PDCCH resource costs. For ML-related configurations, certain bits of the DCI may be used to indicate the ML model configuration and/or as a triggering mechanism for triggering the configuration of the ML model at the UE. The ML model configuration may be based on combining a backbone/general block with a specific/dedicated block to generate a combined ML model. The combined ML model refers to an ML model that is generated based on associating a specific/dedicated block with a backbone/general block. A “block” refers to at least a portion of the algorithm that is trained to recognize the certain types of patterns associated with the processing operation. A general block, or block that is common to multiple ML models, may also be referred to as a “backbone” block. A block that is specific to a particular ML model may be referred to as a “specific” block or as a “dedicated” block. An association between the backbone/general block and the specific/dedicated block may be determined based on a task/condition of the UE. The association may provide reduced signaling costs and flexibility for ML model configurations for different tasks/conditions of the UE.

One or more bits of the DCI may be used to trigger a particular combination between the backbone/general blocks and the specific/dedicated blocks for generating the combined ML model for a particular task/condition. A set of DCI bits in the PDCCH may indicate the combined ML model, which may be comprised of a backbone/general block and a specific/dedicated block. That is, the “set of DCI bits” is an allocation of the one or more bits of the DCI used to trigger the combined ML model and refers to one or more first bits of the allocation that indicate the backbone/general block to be used for the combined ML model and one or more second bits of the allocation that indicate the specific/dedicated block to be used for the combined ML model.

In a first aspect, the indications for the backbone/general blocks and the specific/dedicated blocks may be included in separate DCI domains. That is, a first DCI domain may correspond to the backbone/general blocks and a second DCI domain, which may be independently configured by the network, may correspond to the specific/dedicated blocks. “DCI domain” may refer to an ML portion of a DCI bit sequence, which may include a first portion indicative of backbone/general block tasks/conditions and a second portion indicative of specific/dedicated block tasks/conditions. In a second aspect, the indications for the backbone/general blocks and the specific/dedicated blocks may be included in a joint indication from the network in association with a same DCI domain. The joint indication may indicate to the UE that the specific/dedicated block is to be associated with the backbone/general block of the same DCI domain to provide the combined ML model without the UE having to execute additional association protocols. In a third aspect, the one or more bits of the DCI may indicate the specific/dedicated blocks, but may not indicate the backbone/general blocks. However, since each specific/dedicated block parameter configuration may include a parameter for a backbone/general block index, the UE may perform the association based on a mapping to the backbone/general block. In a fourth aspect, a trigger state indicative of the association between the backbone/general block and the specific/dedicated block may be indicated in an RRC message. The DCI may indicate a trigger state index for the trigger state, where each trigger state may indicate one or more sets of backbone/general blocks and specific/dedicated blocks for generating the combined ML model.

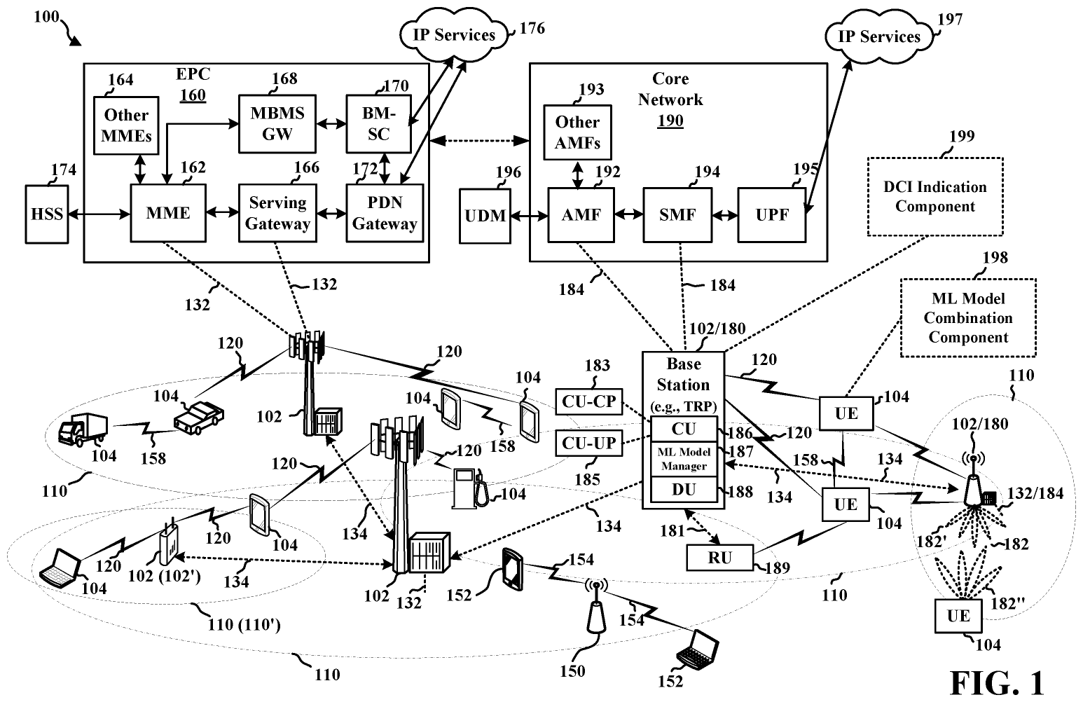

FIG. 1 is a diagram illustrating an example of a wireless communications system and an access network 100. Referring to FIG. 1, in certain aspects, a UE 104 may include an ML model combination component 198 configured to receive DCI for at least one of triggering or determining a configuration of an ML model, the configuration of the ML model based on an association between at least one first ML block for a first procedure and at least one second ML block for a second procedure, the at least one second ML block dedicated to a task included in a plurality of tasks associated with the at least one first ML block; and configure the ML model including the association between the at least one first ML block for the first procedure and the at least one second ML block for the second procedure based on the DCI for at least one of triggering or determining the configuration of the ML model. In certain aspects, a base station 180 may include a DCI indication component 199 configured to set one or more bits of DCI that at least one of indicate or trigger a configuration of an ML model at a UE, the configuration of the ML model based on an association between at least one first ML block for a first procedure and at least one second ML block for a second procedure, the at least one second ML block dedicated to a task included in a plurality of tasks associated with the at least one first ML block; and transmit the DCI that at least one of indicates or triggers the configuration of the ML model at the UE based on setting the one or more bits of the DCI. Although the following description may be focused on 5G NR, the concepts described herein may be applicable to other similar areas, such as LTE, LTE-A, CDMA, GSM, and other wireless technologies.

The wireless communications system (also referred to as a wireless wide area network (WWAN)) in FIG. 1 is illustrated to include base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, which may be associated with the second backhaul link 184 from the base station 102, other AMFs 193, a Session Management Function (SMF) 194, which may also be associated with the second backhaul link 184 from the base station 102, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 may include a centralized unit (CU) 186 for higher layers of a protocol stack and/or a distributed unit (DU) 188 for lower layers of the protocol stack. The CU 186 may be associated with a CU-control plane (CU-CP) 183 and a CU-user plane (CU-UP) 185. The CU-CP 183 may be a logical node that hosts a radio resource control (RRC) and a control portion of a packet data convergence protocol (PDCP). The CU-UP 185 may be a logical node that hosts a user plane portion of the PDCP. The base station 102 may also include an ML model manager 187 that may authorize the UE 104 to download one or more ML models from the network. In further aspects, the base station 102 may communicate with a radio unit (RU) 189 over a fronthaul link 181. For example, the RU 189 may relay communications between the DU 188 and the UE 104. Accordingly, while some functions, operations, procedures, etc., may be described herein for exemplary purposes in association with a base station, the functions, operations, procedures, etc., may be additionally or alternatively performed by other devices, such as devices associated with open-RAN (O-RAN) deployments.

The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

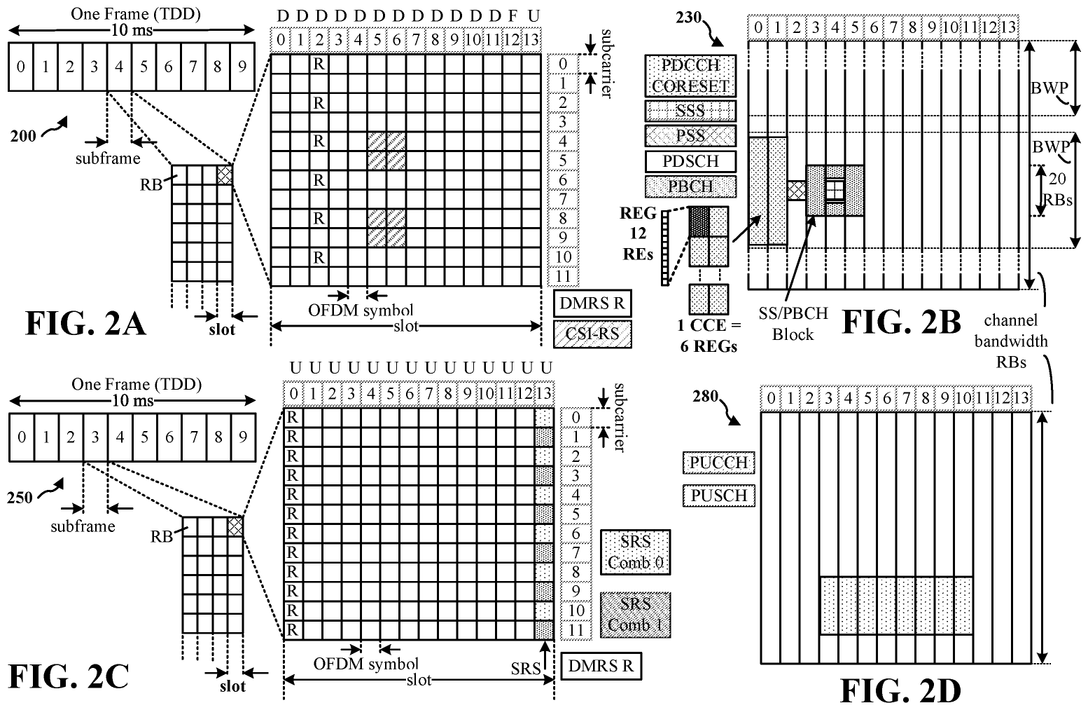

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DCI, or semi-statically/statically through RRC signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

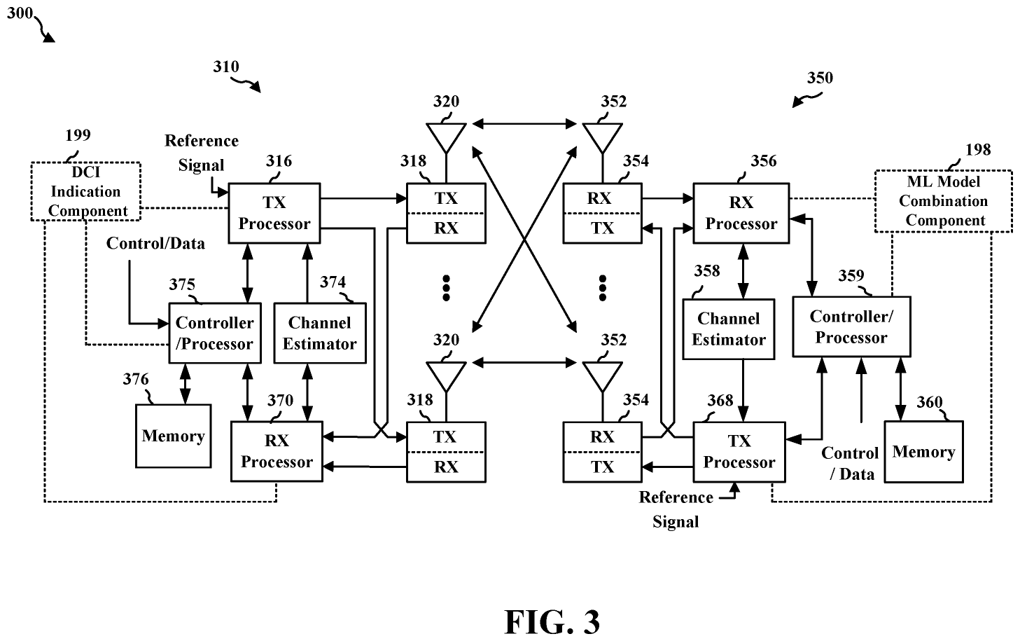

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a PDCP layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, channels, mapping onto physical modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the ML model combination component 198 of FIG. 1.

At least one of the TX processor 316, the RX processor 370, and the controller/processor 375 may be configured to perform aspects in connection with the DCI indication component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

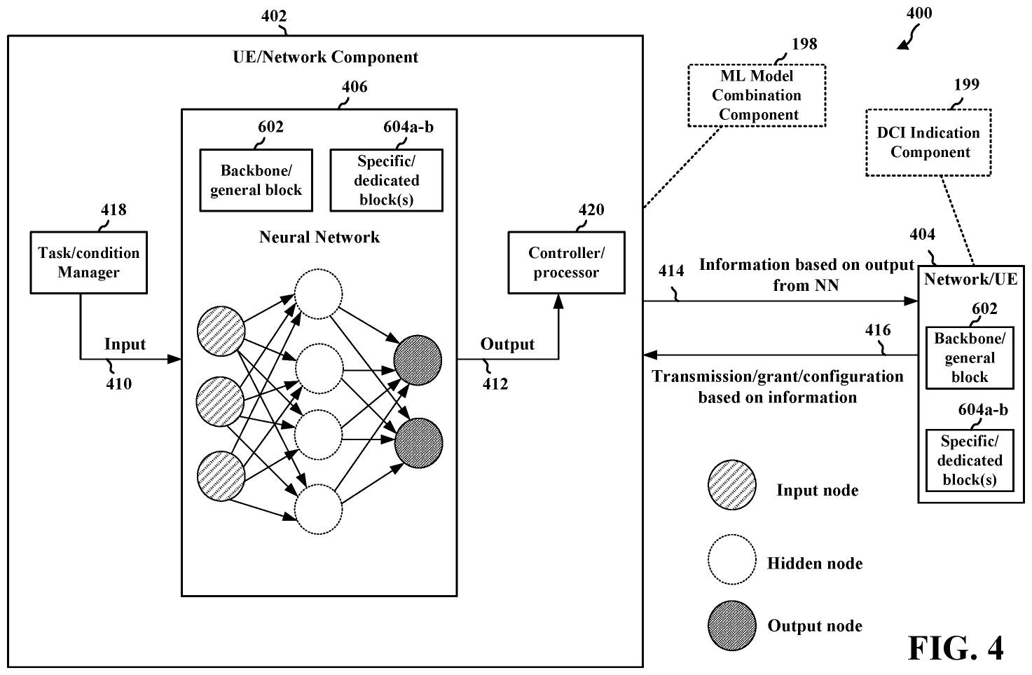

FIG. 4 illustrates a diagram 400 of a first wireless communication device 402 that includes a neural network 406 configured for determining communications with a second device 404. In some aspects, the neural network 406 may be included in a UE. The first wireless communication device 402 may be a UE, and the second device 404 may correspond to a second UE, a base station, or other network component, such as a core network component. In some aspects, the neural network 406 may be included in a network component. The first wireless communication device 402 may be one network component, and the second device 404 may be a second network component. A UE and/or a base station (e.g., including a CU and/or a DU) may use machine-learning algorithms, deep-learning algorithms, neural networks, reinforcement learning, regression, boosting, or advanced signal processing methods for aspects of wireless communication, e.g., with a base station, a TRP, another UE, etc. The CU may provide higher layers of a protocol stack, such the SDAP, PDCP, RRC, etc., while the DU may provide lower layers of the protocol stack, such as the RLC, MAC, PHY, etc. A single CU may control multiple DUs, and each DU may be associated with one or more cells.

Reinforcement learning is a type of machine learning that involves the concept of taking actions in an environment in order to maximize a reward. Reinforcement learning is a machine learning paradigm; other paradigms include supervised learning and unsupervised learning. Basic reinforcement may be modeled as a Markov decision process (MDP) having a set of environment and agent states, and a set of actions of the agent. The process may include a probability of a state transition based on an action and a representation of a reward after the transition. The agent's action selection may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples. Federated learning (FL) procedures that use edge devices as clients may rely on the clients being trained based on supervised learning.

Regression analysis may include statistical processes for estimating the relationships between a dependent variable (e.g., which may be referred to as an outcome variable) and independent variable(s). Linear regression is one example of regression analysis. Non-linear models may also be used. Regression analysis may include inferring causal relationships between variables in a dataset.

Boosting includes one or more algorithms for reducing bias and/or variance in supervised learning, such as machine learning algorithms that convert weak learners (e.g., a classifier that is slightly correlated with a true classification) to strong ones (e.g., a classifier that is more closely correlated with the true classification). Boosting may include iterative learning based on weak classifiers with respect to a distribution that is added to a strong classifier. The weak learners may be weighted related to accuracy. The data weights may be readjusted through the process. In some aspects described herein, an encoding device (e.g., a UE, base station, or other network component) may train one or more neural networks to learn dependence of measured qualities on individual parameters.

The second device 404 may be a base station in some examples. The second device 404 may be a TRP in some examples. The second device 404 may be a network component, such as a DU, in some examples. The second device 404 may be another UE in some examples, e.g., if the communication between the first wireless device 402 and the second device 404 is based on sidelink. Although some example aspects of machine learning and a neural network are described for an example of a UE, the aspects may similarly be applied by a base station, an IAB node, or another training host.

Among others, examples of machine learning models or neural networks that may be included in the first wireless device 402 include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with an input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. FIG. 4 illustrates that an example neural network 406 may include a network of interconnected nodes. An output of one node is connected as the input to another node. Connections between nodes may be referred to as edges, and weights may be applied to the connections/edges to adjust the output from one node that is applied as the input to another node. Nodes may apply thresholds in order to determine whether, or when, to provide output to a connected node. The output of each node may be calculated as a non-linear function of a sum of the inputs to the node. The neural network 406 may include any number of nodes and any type of connections between nodes. The neural network 406 may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times. As an example, the first wireless device 402 may input information 410 to the neural network 406 (e.g., via a task/condition manager 418), and may receive output 412. The first wireless device 402 may report information 414 to the second device 404 based on the output 412. In some aspects, the second device may transmit communication to the first wireless device 402 based on the information 414. In some aspects, the second device 404 may be a base station that schedules or configures a UE (e.g., the first wireless device 402) based on the information 414, e.g., at 416. In other aspects, the base station may collect information from multiple training hosts, e.g., from multiple UEs. Similarly, a network may collect information from multiple training hosts including multiple base stations, multiple IAB nodes, and/or multiple UEs, among other examples.

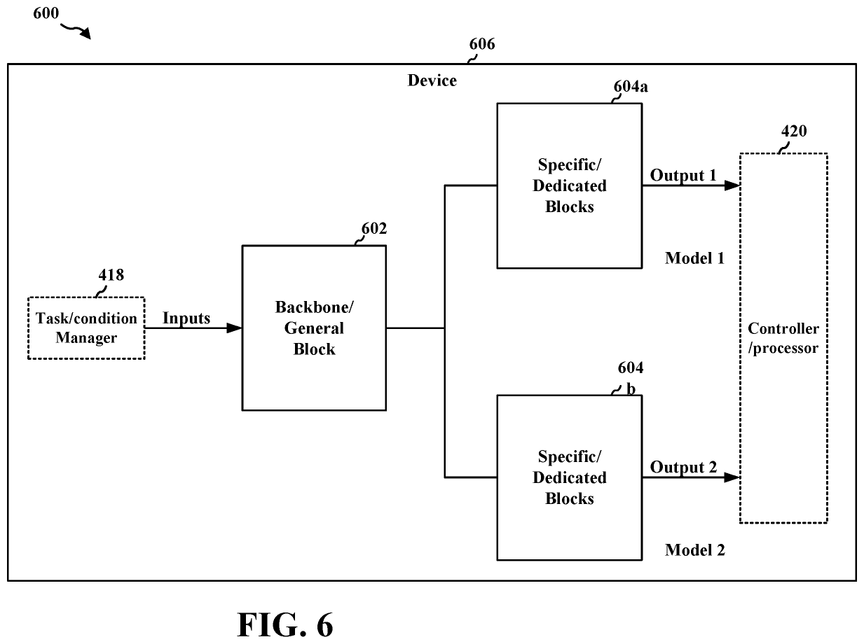

The first wireless device 402 may be configured to perform aspects in connection with the ML model combination component 198 of FIG. 1. For example, the first wireless device 402 may be a first UE or a network component that includes the ML model combination component 198 of FIG. 1, one or more backbone/general blocks 602, and one or more specific/dedicated block(s) 604a-604b (described in further detail in FIG. 6). The ML model combination component 198 may be configured to combined, based on a DCI trigger, the backbone/general block 602 with one or more specific/dedicated block(s) 604a-604b to generate a combined ML model.

The second wireless device 404 may be configured to perform aspects in connection with the DCI indication component 199 of FIG. 1. For example, the second wireless device 404 may be a network or a second UE that includes the DCI indication component 199 of FIG. 1, one or more backbone/general blocks 602, and one or more specific/dedicated block(s) 604a-604b (described in further detail in FIG. 6). The DCI indication component 199 may be configured to set one or more DCI triggering bits for triggering a configuration of a combined ML model at the first wireless device 402 based on an association between the backbone/general block 602 and the one or more specific/dedicated block(s) 604a-604b (described in further detail in FIG. 6).

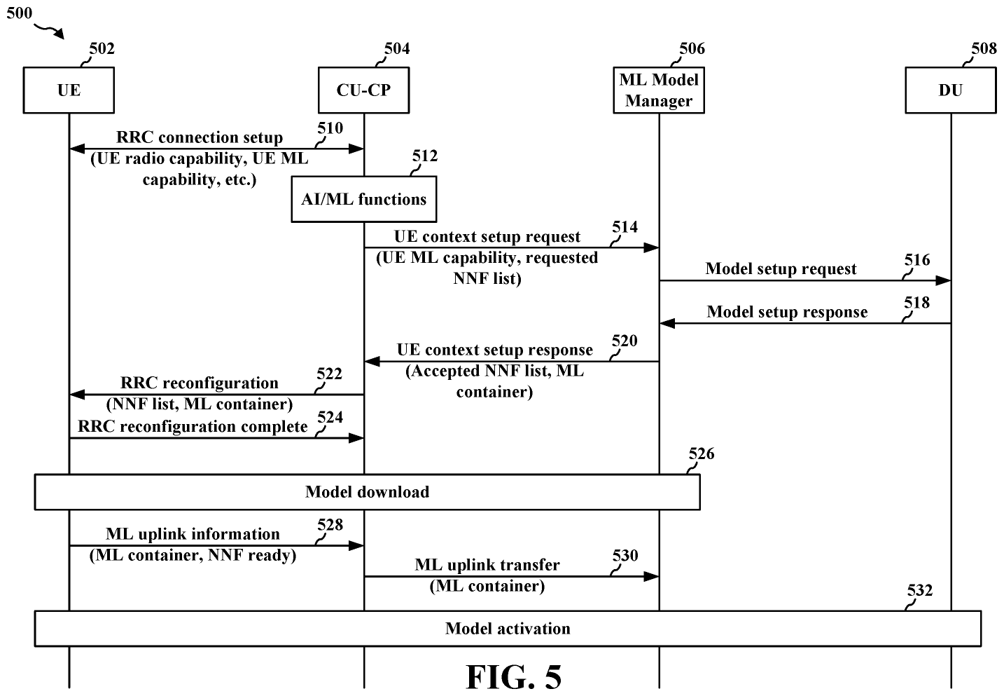

FIG. 5 is a call flow diagram 500 illustrating communications between a UE 502 and a network including a centralized unit-control plane (CU-CP) 504, a machine learning (ML) model manager 506, and a distributed unit (DU) 508. ML model inferencing techniques may be associated with deployment and configuration of an ML model via a three-phase procedure. In a first phase of the three-phase procedure, an RRC connection may be established between the UE 502 and the network (e.g., CU-CP 504) to provide a configuration for the ML model deployment. For example, the UE 502 may perform, at 510, an RRC connection setup with the CU-CP 504. The RRC connection setup, at 510, may be indicative of a UE radio capability, a UE ML capability, etc.

The CU-CP 504 may be configured to utilize, at 512, artificial intelligence (AI)/ML capabilities for one or more AI/ML functions at the CU-CP 504. The AI/ML functions 512 may correspond to any of the techniques described in connection with FIG. 4 and/or other AI/ML techniques. The CU-CP 504 may transmit, at 514, a UE context setup request to the ML model manager 506. The transmitted request may be indicative of the UE ML capability, a requested neural network filtering (NNF) list, etc. The ML model manager 506 may transmit, at 516, a model setup request to the DU 508 based on the UE context setup request received, at 514, from the CU-CP 504. In response to the model setup request, the DU 508 may transmit, at 518, a model setup response to the ML model manager 506. The ML model manager 506 may similarly transmit, at 520, a UE context setup response to the CU-CP 504 based on the model setup response received, at 518, from the DU 508. The UE context setup response may be indicative of an accepted NNF list, an ML container, etc.

The CU-CP 504 may transmit, at 522, an RRC reconfiguration to the UE 502 based on the UE context setup response received, at 520, from the ML model manager 506. The RRC reconfiguration may be indicative of the NNF list, the ML container, etc. Responsive to receiving the RRC reconfiguration, at 522, the UE 502 may transmit, at 524, an RRC reconfiguration complete message to the CU-CP 504 to indicate that the RRC connection has been established between the UE 502 and the network.

A second phase of the three-phase procedure may correspond to an ML model download procedure. The network may configure one or more ML models at a designated node in the network, such as at the ML model manager 506. The UE 502 may download, at 526, the one or more ML models from the designated node in the network (e.g., from the ML model manager 506 via the CU-CP 504).

A third phase of the three-phase procedure may correspond to an ML model activation procedure. The downloaded ML model may be used by the UE 502 in association with performing a particular task/condition. For example, the condition may correspond to UE positioning, and separate tasks of the condition may correspond to an indoor positioning task and an outdoor positioning task. In another example, the condition may correspond to a CSF measurement, and separate tasks of the condition may correspond to CSF per BWP task, a CSF in high Doppler task, and a CSF with decreased feedback task. In yet another example, the condition may correspond to data decoding, and separate tasks of the condition may correspond to a decoding task in a low signal-to-ratio (SNR), a decoding task in a high SNR, and a decoding per base graph (BG) task. The UE 502 may transmit, at 528, ML uplink information to the CU-CP 504 such as the ML model container, an NNF ready indication, etc. The CU-CP 504 may subsequently transmit, at 530, an ML uplink transfer indication (e.g., ML container) to the ML model manager 506 for performing, at 532, ML model activation among the UE 502 and the nodes of the network.

FIG. 6 is a diagram 600 that illustrates inputs and outputs for a plurality of combined ML models executed by a device 606. The device 606 may be a UE, a base station, other network entity, etc. The plurality of combined ML models may be configured to share a same backbone/general block 602, but have separate specific/dedicated blocks 604a-604b. The backbone/general block 602 and the specific/dedicated blocks 604a-604b may be included at a same device. The plurality of combined ML models may correspond to a first model/model 1 and a second model/model 2, where both the first model and the second model receive inputs at the backbone/general block 602 (e.g., from the task/condition manager 418), but the first model provides a first output/output 1 from a first specific/dedicated block 604a (e.g., to the controller/processor 420) and the second model provides a second output/output 2 from a second specific/dedicated block 604b (e.g., to the controller/processor 420). The backbone/general block 602 may be based on a periodic configuration or a static configuration. The specific/dedicated blocks 604a-604b in the combined ML models may then be updated or changed for adapting the combined ML models to different tasks and conditions. Configuring combined ML models based on a shared backbone/general block 602 may provide reduced signaling cost.

The network may separately configure the two blocks of the combined ML model to the UE. That is, the network may configure the backbone/general block 602 to the UE separately from configuring the specific/dedicated blocks 604a-604b to the UE. For example, the backbone/general block 602 may be initially configured to the UE but, based on different tasks/conditions, the network may later determine to configured the one or more specific/dedicated blocks 604a-604b to the UE. The configuration of the combined ML model may be flexible, and may also be performed within a certain amount of time, to be dynamically adapted to different tasks/conditions of the UE.

While a DCI-based indication for the combined ML model may reduce a time for configuring the combined ML model, PDCCH resources associated with the configuration may be limited. Thus, a DCI-based indication for dynamically adapting the ML model configuration may be balanced with PDCCH resource costs. Search space sets and associated DCI formats may be diverse. Hence, DCI indicative of a resource allocation may be configured based on a number of different DCI formats.

For ML-related configurations, DCI may be used to indicate the ML model configuration and/or as a triggering mechanism for the ML model. A certain format or domain may be used to provide the ML-related information. For example, the DCI configuration may be used to indicate the backbone/general block 602 and the specific/dedicated blocks 604a-604b to be used for generating the combined ML models. The ML model may also be adapted based on indications of the DCI for different tasks/conditions of the UE.

The combined ML models may be triggered via DCI based on a number of techniques for indicating the backbone/general block 602 and the specific/dedicated blocks 604a-604b, including techniques for determining the associations between the backbone/general block 602 and the specific/dedicated blocks 604a-604b. Such techniques may reduce signaling cost and provide flexible indications for the combined ML models in order to adapt and enable the combined ML models for different tasks/conditions of the UE. Thus, in addition to determining the associations between the backbone/general block 602 and the specific/dedicated blocks 604a-604b (e.g., based on configured parameters), DCI may be used to trigger a particular combination between the backbone/general block 602 and the specific/dedicated blocks 604a-604b for generating a combined ML model.

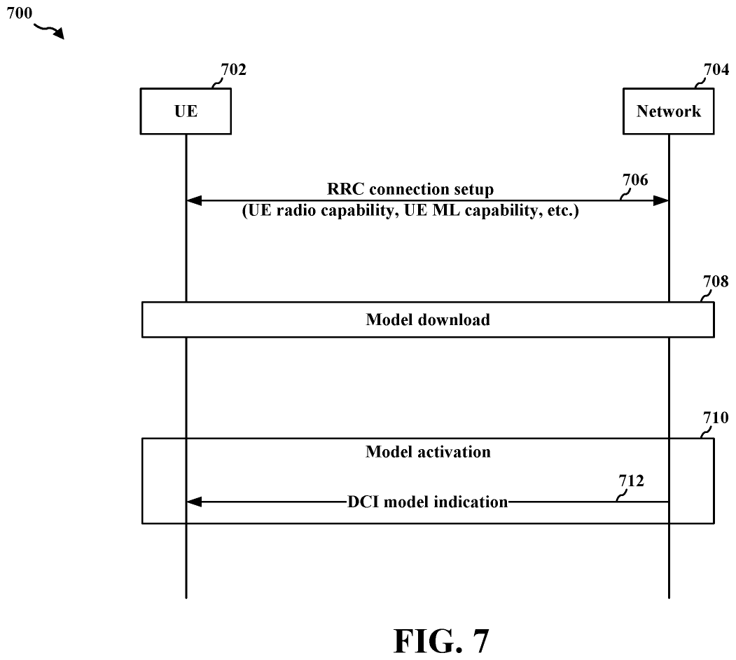

FIG. 7 is a call flow diagram 700 illustrating communications between a UE 702 and a network 704. The communications may be associated with DCI-based model indication and triggering. In PDCCH, a set of DCI bits may be used to indicate the ML models to the UE. A combined ML model may include two portions that correspond to the backbone block and the specific/dedicated block. Thus, a first bit in the DCI may indicate the backbone block to be used for the combined ML model and a second bit in the DCI may indicate the specific/dedicated block to be used for the combined ML model.

The UE 702 may perform, at 706, an RRC connection setup with a network entity, such as a CU-CP of the network 704. The RRC connection setup may be used by the UE 702 to report a UE radio capability, a UE ML capability, etc., to the network 704. After the RRC connection is established between the UE 702 and the network 704, the UE 702 may download, at 708, one or more ML models from a node of the network 704. For example, the UE 702 may download, at 708, the ML model from an ML model manager via the CU-CP. Model downloading procedures performed, at 708, may provide multiple backbone blocks and/or multiple specific/dedicated blocks to the UE 702 for generating the combined ML model. Thus, the UE 702 may receive, at 708, a plurality of backbone blocks and/or a plurality of specific/dedicated blocks.

The network 704 may utilize DCI to indicate an association between a particular backbone block and a particular specific/dedicated block for generating a combined ML model for a particular task/condition of the UE 702. Based on the task/condition of the UE 702 and the configuration for the backbone blocks and the specific/dedicated blocks, a DCI model indication may be transmitted, at 712, from the network 704 to the UE 702 to enable the combined ML model including the backbone blocks and the specific/dedicated blocks.

The network may transmit, at 712, the DCI model indication to the UE 702 as part of a model activation procedure performed, at 710. The DCI may be triggered/scheduled to indicate the particular backbone block for the combined ML model, and either separate DCI or joint DCI may be triggered/scheduled to indicate the specific/dedicated block for the combined ML model. The DCI model indication may indicate, at 712, the specific/dedicated blocks in the DCI domain and/or indicate a trigger state index for triggering the combined ML model. The UE 702 may combine the backbone blocks and the specific/dedicated blocks to generated the combined ML model based on the DCI model indication received, at 712, from the network 704.

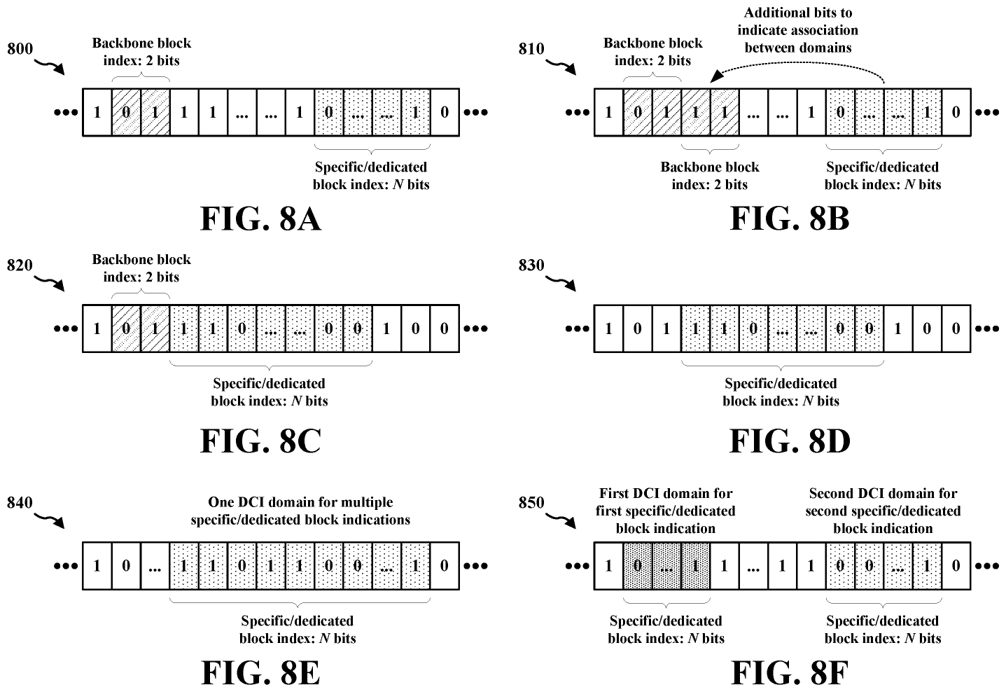

FIGS. 8A-8F illustrates bit sequence diagrams 800-850 for backbone blocks and specific/dedicated blocks. A CORESET and a search space set may be indicative of a portion of DCI that is associated with physical resources. The DCI may include a sequence of bits, where a first portion of the sequence/bits may correspond to a first task/condition and a second portion of the sequence/bits may correspond to a second task/condition. The “DCI domain” may refer to an ML portion of the sequence/bits (e.g., the one or more bits used to indicate the backbone blocks and the specific/dedicated blocks for the combined ML model).

In a first example, the indications for the backbone blocks and the specific/dedicated blocks may be included in separate DCI domains. That is, a first DCI domain may correspond to the backbone blocks and a second DCI domain may correspond to the specific/dedicated blocks. The separate DCI domains may be independently configured. For example, the bit sequence diagram 800 of FIG. 8A includes two 2 bits for one backbone block indication in a first DCI domain, and N bits for one specific/dedicated block indication in a second DCI domain.

If one backbone block is configured, the indicated specific/dedicated blocks may be dynamically associated with the one backbone block. For instance, the one backbone block in the bit sequence diagram 800 may be indicated via 2 bits that correspond to a backbone block index that provides a mapping to a backbone block identifier (ID). With one backbone block being configured in the bit sequence diagram 800, the specific/dedicated blocks may each be associated with the one backbone block via N bits that correspond to a specific/dedicated block index that provides a mapping to a specific/dedicated block ID.

If multiple backbone blocks are configured, additional bits may be utilized in the bit sequence to indicate associations between particular backbone blocks and particular specific/dedicated blocks. A first DCI domain may be used to configure the backbone blocks and a second DCI domain may be used to configure the specific/dedicated blocks. The bit sequence diagram 810 of FIG. 8B includes a plurality of backbone blocks that may be associated with a plurality specific/dedicated blocks. In the bit sequence diagram 810, a first set of 2 bits may correspond to a first backbone block and a second set of 2 bits may correspond to a second set of 2 bits for a second backbone block. The additional bits may indicate the association between the separate DCI domains in order to indicate which specific/dedicated block is to be combined with which backbone block.

In a second example, the indications for the backbone blocks and the specific/dedicated blocks may be a joint indication included in a same DCI domain. That is, the one or more bits may be included in a same ML DCI domain. For example, in the bit sequence diagram 820 of FIG. 8C, 2 bits may be used to indicate the backbone block, and N bits may be used to indicate the specific/dedicated block in the same DCI domain. One backbone block configuration and one specific/dedicated block configuration may be included in one ML DCI domain. Thus, the UE may not execute particular association protocols to determine the association between the backbone block and the specific/dedicated block. Since the backbone block and the specific/dedicated block are configured together in the same DCI domain, the specific/dedicated block bits may be combined with the backbone block bits to provide the combined ML model. The joint indication being performed together in the same DCI domain indicates to the UE that the specific/dedicated block is to be associated with the backbone block that is also indicated in the same DCI domain.

In a third example, such as in the bit sequence diagram 830 of FIG. 8D, the one or more bits may indicate the specific/dedicated blocks, but not indicate the backbone blocks. Each specific/dedicated block parameter configuration may include a parameter for a backbone block index, which may be used to perform the association between the backbone block and the specific/dedicated block. For example, the specific/dedicated block configuration may be based on one or more of a specific/dedicated block index, ML model content, or an associated backbone block index. After the specific/dedicated block is indicated, the UE may determine the backbone block to be associated with the specific/dedicated block based on the backbone block index included in the specific/dedicated block configuration. The specific/dedicated block configuration may be configured via RRC signaling during a model download procedure.

For the specific/dedicated block configuration, the specific/dedicated block indicated and configured via the DCI domain may include a plurality of specific/dedicated blocks. Each of the configured specific/dedicated blocks may be associated with one backbone block. For example, in the bit sequence diagram 840 of FIG. 8E, one DCI domain may be used to indicate the plurality of specific/dedicated blocks. Alternatively, in the bit sequence diagram 850 of FIG. 8F, the specific/dedicated block indicated and configured via the DCI domain may correspond to a single specific/dedicated block. Thus, another DCI domain may be used to indicate another specific/dedicated block configuration, as each specific/dedicated block may correspond to a different DCI domain. Hence, multiple specific/dedicated blocks may be configured based on multiple DCI domains.

In a fourth example, a trigger state indicative of an association between the backbone blocks and the specific/dedicated blocks may be indicated in an RRC message. The DCI may also indicate a trigger state index for the trigger state. Each trigger state may correspond to one or more sets of backbone blocks and specific/dedicated blocks. For example, N sets of trigger states may be indicated in the RRC message. The DCI may utilize 4 bits to indicate the trigger state. The DCI may not explicitly indicate the backbone blocks and the specific/dedicated blocks or the corresponding association, but may indicate a predefined trigger state in the RRC message. The trigger state may trigger the combined ML model and/or association protocols via RRC signaling.

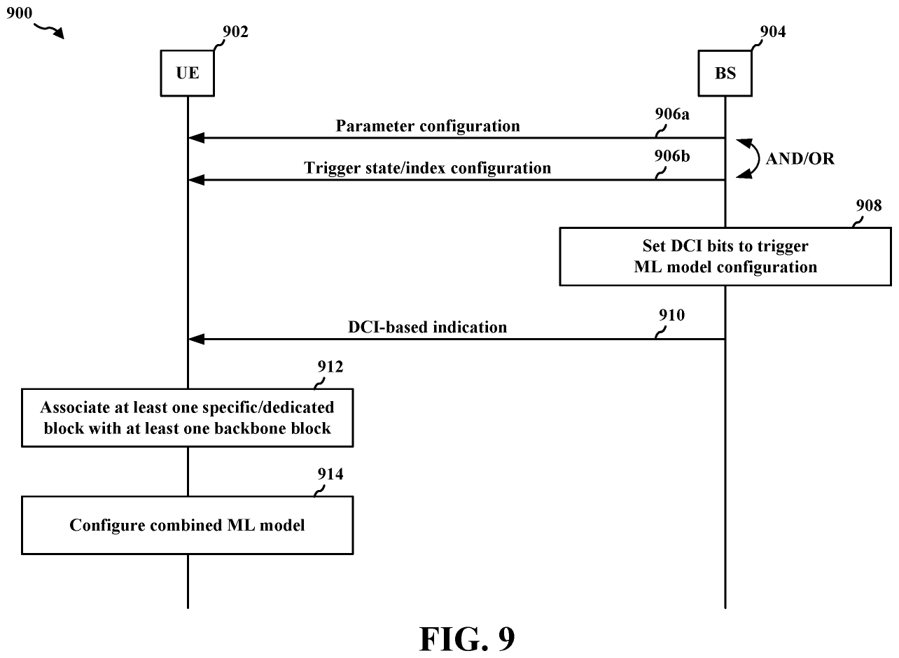

FIG. 9 is a call flow diagram 900 illustrating communications between a UE 902 and a base station 904. At 906a, the base station 904 may transmit a parameter configuration to the UE 902. The parameter configuration may be indicative of a parameter index for associating one or more specific/dedicated blocks with one or more backbone blocks to provide a combined ML model. Additionally or alternatively to the parameter configuration transmitted, at 906a, the base station 904 may transmit, at 906b, a trigger state/index configuration to the UE 902. The trigger state/index configuration may trigger the UE 902 to configure the combined ML model (e.g., based on a trigger index or an indicated trigger state).

At 908, the base station 904 may set DCI bits to trigger an ML model configuration at the UE. The one or more bits may be indicative of the one or more backbone blocks to be used for the ML model, the one or more specific/dedicated blocks to be used for the ML model, or combinations thereof. At 910, the base station 904 may transmit, to the UE 902, a DCI-based indication including the DCI bits for triggering the ML model configuration.

At 912, the UE may associate at least one specific/dedicated block with at least one backbone block (e.g., based on the DCI-based indication received, at 910). For example, the one or more specific/dedicated blocks may be associated, at 912, with a single backbone block. Alternatively, the one or more specific/dedicated blocks may be associated, at 912, with a plurality of backbone blocks. At 914, the UE 902 may configure the combined ML model based on the association between the one or more specific/dedicated blocks and the one or more backbone blocks.

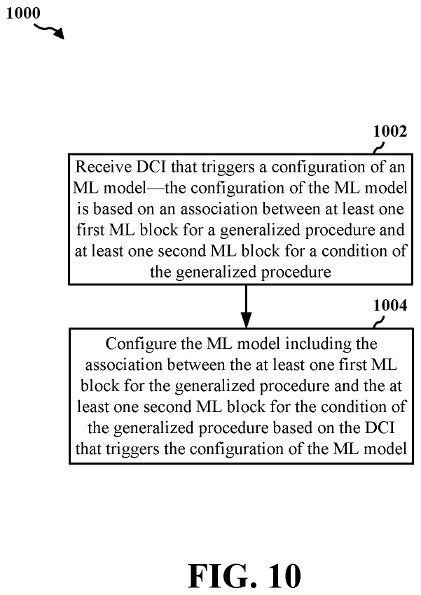

FIG. 10 is a flowchart 1000 of a method of wireless communication. The method may be performed by a UE (e.g., the UE 104, 402, 502, 702, 902; the apparatus 1402; etc.), which may include the memory 360 and which may be the entire UE 104, 402, 502, 702, 902 or a component of the UE 104, 402, 502, 702, 902, such as the TX processor 368, the RX processor 356, and/or the controller/processor 359. The method may provide reduced signaling costs and increased robustness for configuring combined ML models based on different tasks/conditions.

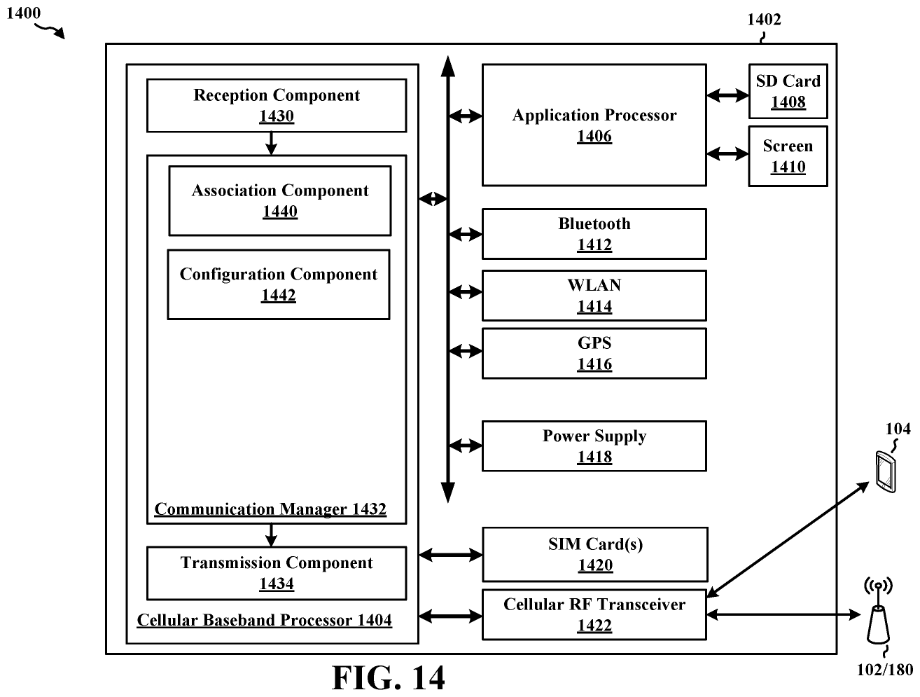

At 1002, the UE may receive DCI that triggers a configuration of an ML model—the configuration of the ML model is based on an association between at least one first ML block for a generalized procedure and at least one second ML block for a condition of the generalized procedure. For example, referring to FIGS. 7 and 9, the UE 902 may receive, at 910, a DCI-based indication from the base station 904. The DCI-based indication received, at 910, may trigger configuration, at 914, of a combined ML model based on an association, at 912, of a specific/dedicated block with a backbone block. In the call flow diagram 700, the UE 702 may receive, at 712, a DCI model indication from the network 704 to trigger model activation, at 708. The reception, at 1002, may be performed by the reception component 1430 of the apparatus 1402 in FIG. 14.

At 1006, the UE may configure the ML model including the association between the at least one first ML block for the generalized procedure and the at least one second ML block for the condition of the generalized procedure based on the DCI that triggers the configuration of the ML model. For example, referring to FIGS. 6 and 9, the UE 902 may configure, at 914, the combined ML model based on the DCI-based indication received, at 910, from the base station 904 and the association, at 912, of the at least one specific/designated block (e.g., the specific/dedicated blocks 604a-604b) with the at least one backbone block (e.g., the backbone/general block 602). The configuration, at 1004, may be performed by the configuration component 1442 of the apparatus 1402 in FIG. 14.

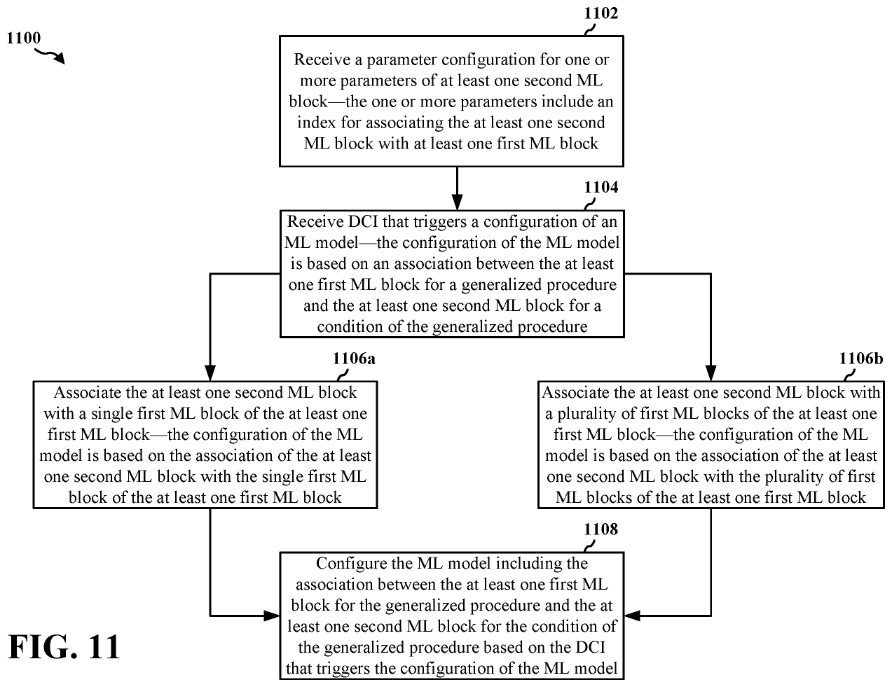

FIG. 11 is a flowchart 1100 of a method of wireless communication. The method may be performed by a UE (e.g., the UE 104, 402, 502, 702, 902; the apparatus 1402; etc.), which may include the memory 360 and which may be the entire UE 104, 402, 502, 702, 902 or a component of the UE 104, 402, 502, 702, 902, such as the TX processor 368, the RX processor 356, and/or the controller/processor 359. The method may provide reduced signaling costs and increased robustness for configuring combined ML models based on different tasks/conditions.

At 1102, the UE may receive a parameter configuration for one or more parameters of at least one second ML block—the one or more parameters include an index for associating the at least one second ML block with at least one first ML block. For example, referring to FIGS. 6-9, the UE 902 may receive, at 906a, a parameter configuration from the base station 904. The parameter configuration may include an index for associating the specific/dedicated blocks 604a-604b with a backbone/general block 602. The backbone blocks and the specific/dedicated blocks of the bit sequence diagram 800-850 are also associated based on an ML block index. In the call flow diagram 700, the UE 702 may receive, at 712, a DCI model indication from the network 704 to trigger model activation, at 708. The DCI that triggers, at 910/712, the configuration of the ML model, at 914, may include a second set of bits indicative of the at least one second ML block (e.g., the specific/dedicated blocks 604a-604b), such that the association between the at least one first ML block (e.g., the backbone/general block 602) and the at least one second ML block (e.g., the specific/dedicated blocks 604a-604b) may be based on indexing the at least one second ML block to the at least one first ML block via the second set of bits, as indicated in FIG. 8, and based on the parameter configuration, at 906a, for the one or more parameters. The reception, at 1102, may be performed by the reception component 1430 of the apparatus 1402 in FIG. 14.

At 1104, the UE may receive DCI that triggers a configuration of an ML model—the configuration of the ML model is based on an association between the at least one first ML block for a generalized procedure and the at least one second ML block for a condition of the generalized procedure. For example, referring to FIGS. 6-9, the UE 902 may receive, at 910, a DCI-based indication from the base station 904. The DCI-based indication received, at 910, may trigger configuration, at 914, of a combined ML model based on an association, at 912, of a specific/dedicated block with a backbone block. The DCI may indicate, at 906b, a trigger state/index for triggering the configuration, at 914, of the ML model. The trigger index may be indicative of one or more trigger states that correspond to one or more associations between the at least one first ML block (e.g., the backbone/general block 602) and the at least one second ML block (e.g., the specific/dedicated blocks 604a-604b). The one or more trigger states may be configured, at 906b, via an RRC message. The reception, at 1104, may be performed by the reception component 1430 of the apparatus 1402 in FIG. 14.

The at least one first ML block may correspond to a backbone block (e.g., the backbone/general block 602) and the at least one second ML block may correspond to a dedicated block (e.g., the specific/dedicated blocks 604a-604b). The DCI that triggers, at 910/712, the configuration, at 914, of the ML model may include a first DCI domain and a second DCI domain. As indicated in the bit sequence diagrams 800-820, the first DCI domain may include a first set of bits indicative of the at least one first ML block (e.g., the backbone/general block 602) and the second DCI domain may include a second set of bits indicative of the at least one second ML block (e.g., the specific/dedicated blocks 604a-604b). In the bit sequence diagram 800, the first set of bits may be indicative of a single first ML block of the at least one first ML block (e.g., the backbone/general block 602) and the at least one second ML block (e.g., the specific/dedicated blocks 604a-604b) may be associated with the single first ML block based on the first set of bits being indicative of the single first ML block. In the bit sequence diagram 810, the first set of bits may be indicative of a plurality of first ML blocks of the at least one first ML block (e.g., the backbone/general block 602) and the at least one second ML block (e.g., the specific/dedicated blocks 604a-604b) associated with the plurality of first ML blocks may be based on the second set of bits being indicative of the association between the at least one second ML block and the plurality of first ML blocks. The DCI that triggers, at 910/712, the configuration, at 914, of the ML model may include, in a same DCI domain, a first set of bits indicative of the at least one first ML block (e.g., the backbone/general block 602) and a second set of bits indicative of the at least one second ML block (e.g., the specific/dedicated blocks 604a-604b). In the bit sequence diagram 820, the association between the at least one first ML block (e.g., the backbone/general block 602) and the at least one second ML block (e.g., the specific/dedicated blocks 604a-604b) may be based on the first set of bits and the second set of bits being included in the same DCI domain.

At 1106a, the UE may associate the at least one second ML block with a single first ML block of the at least one first ML block—the configuration of the ML model is based on the association of the at least one second ML block with the single first ML block of the at least one first ML block. For example, referring to FIGS. 6 and 9, the UE 902 may associate, at 912, the specific/designated blocks 604a-604b with the backbone/general block 602 for configuring, at 914, the combined ML model. The association, at 1106a, may be performed by the association component 1440 of the apparatus 1402 in FIG. 14.

At 1106b, the UE may alternatively associate the at least one second ML block with a plurality of first ML blocks of the at least one first ML block—the configuration of the ML model is based on the association of the at least one second ML block with the plurality of first ML blocks of the at least one first ML block. For example, referring to FIG. 9, the UE 902 may associate, at 912, at least one specific/designated block with at least one backbone block for configuring, at 914, the combined ML model. The association, at 1106b, may be performed by the association component 1440 of the apparatus 1402 in FIG. 14.

At 1108, the UE may configure the ML model including the association between the at least one first ML block for the generalized procedure and the at least one second ML block for the condition of the generalized procedure based on the DCI that triggers the configuration of the ML model. For example, referring to FIGS. 6 and 9, the UE 902 may configure, at 914, the combined ML model based on the DCI-based indication received, at 910, from the base station 904 and the association, at 912, of the at least one specific/designated block (e.g., the specific/dedicated blocks 604a-604b) with the at least one backbone block (e.g., the backbone/general block 602). The at least one first ML block (e.g., the backbone/general block 602) and the at least one second ML block (e.g., the specific/dedicated blocks 604a-604b) may each include one or more layers—the one or more layers including at least one of a convolution layer, a fully connected (FC) layer, a pooling layer, or an activation layer. The configuration, at 1108, may be performed by the configuration component 1442 of the apparatus 1402 in FIG. 14.

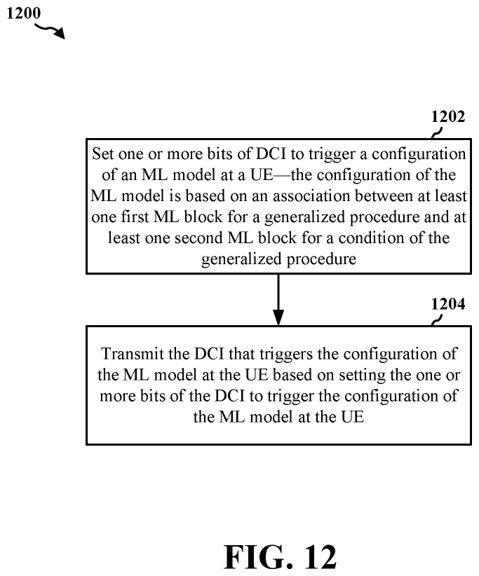

FIG. 12 is a flowchart 1200 of a method of wireless communication. The method may be performed by a base station (e.g., the base station 102, 904; the second device 404; the network 704 including the CU-CP 504, the ML model manager 506, the DU 508; the apparatus 1502; etc.), which may include the memory 376 and which may be the entire base station 102, 904 or a component of the base station 102, 904, such as the TX processor 316, the RX processor 370, and/or the controller/processor 375. The method may provide reduced signaling costs and increased robustness for configuring combined ML models based on different tasks/conditions.

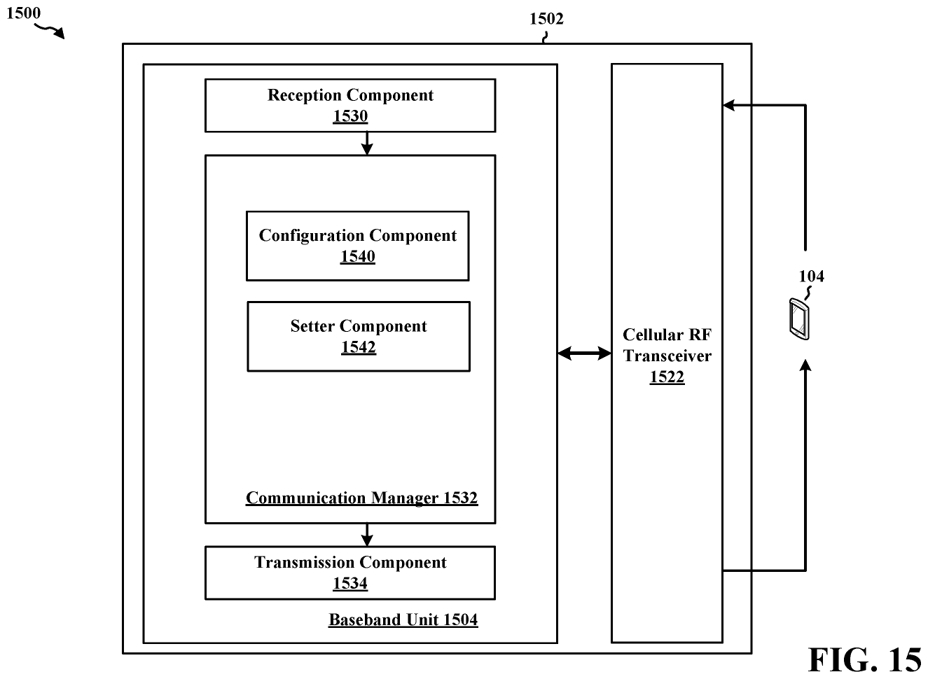

At 1202, the base station may set one or more bits of DCI to trigger a configuration of an ML model at a UE—the configuration of the ML model is based on an association between at least one first ML block for a generalized procedure and at least one second ML block for a condition of the generalized procedure. For example, referring to FIGS. 8-9, the base station 904 may set, at 908, DCI bits to trigger an ML model configuration. The one or more bits of DCI set, at 908, by the base station 904 may correspond to the bit sequence diagrams 800-850. The setting, at 1202, may be performed by the setter component 1542 of the apparatus 1502 in FIG. 15.

At 1204, the base station may transmit the DCI that triggers the configuration of the ML model at the UE based on setting the one or more bits of the DCI to trigger the configuration of the ML model at the UE. For example, referring to FIG. 9, the base station 904 may transmit, at 910, a DCI-based indication to the UE 902 that triggers configuration, at 914, of the combined ML model based on setting, at 908, the DCI bits to trigger the ML model configuration. The transmission, at 1204, may be performed by the transmission component 1534 of the apparatus 1502 in FIG. 15.

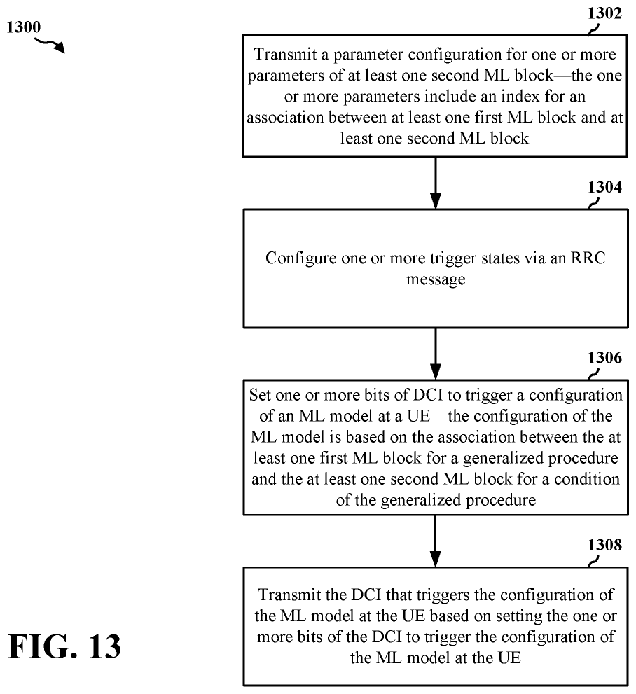

FIG. 13 is a flowchart 1300 of a method of wireless communication. The method may be performed by a base station (e.g., the base station 102, 904; the second device 404; the network 704 including the CU-CP 504, the ML model manager 506, the DU 508; the base station 904; the apparatus 1502 etc.), which may include the memory 376 and which may be the entire base station 102, 904 or a component of the base station 102, 904, such as the TX processor 316, the RX processor 370, and/or the controller/processor 375. The method may provide reduced signaling costs and increased robustness for configuring combined ML models based on different tasks/conditions.

At 1302, the base station may transmit a parameter configuration for one or more parameters of at least one second ML block—the one or more parameters include an index for an association between at least one first ML block and at least one second ML block. For example, referring to FIGS. 6-9, the base station 904 may transmit, at 906a, a parameter configuration to the UE 902. The parameter configuration may include an index for associating the specific/dedicated blocks 604a-604b with a backbone/general block 602. The backbone blocks and the specific/dedicated blocks of the bit sequence diagram 800-850 are also associated based on an ML block index. In the call flow diagram 700, the network may transmit, at 712, a DCI model indication to the UE 702 for performing model activation, at 708. The DCI that triggers, at 910/712, the configuration of the ML model, at 914, may include a second set of bits indicative of the at least one second ML block (e.g., the specific/dedicated blocks 604a-604b), such that the association between the at least one first ML block (e.g., the backbone/general block 602) and the at least one second ML block (e.g., the specific/dedicated blocks 604a-604b) may be based on indexing the at least one second ML block to the at least one first ML block via the second set of bits, as indicated in FIG. 8, and based on the parameter configuration, at 906a, for the one or more parameters. The transmission, at 1302, may be performed by the transmission component 1534 of the apparatus 1502 in FIG. 15.

At 1304, the base station may configure one or more trigger states via an RRC message. For example, referring to FIGS. 6 and 9, the base station 904 may transmit, at 906b, the trigger state/index configuration to the UE 902 via RRC message. The base station 904 may indicate, at 906b, the trigger state/index in DCI for triggering the configuration, at 914, of the ML model. The trigger index may be indicative of one or more trigger states that correspond to one or more associations between the at least one first ML block (e.g., the backbone/general block 602) and the at least one second ML block (e.g., the specific/dedicated blocks 604a-604b). The configuration, at 1304, may be performed by the configuration component 1540 of the apparatus 1502 in FIG. 15.

At 1306, the base station may set one or more bits of DCI to trigger a configuration of an ML model at a UE—the configuration of the ML model is based on the association between the at least one first ML block for a generalized procedure and the at least one second ML block for a condition of the generalized procedure. For example, referring to FIGS. 6 and 8-9, the base station 904 may set, at 908, DCI bits to trigger an ML model configuration. The one or more bits of DCI set, at 908, by the base station 904 may correspond to the bit sequence diagrams 800-850. The at least one first ML block may correspond to a backbone block (e.g., the backbone/general block 602) and the at least one second ML block may correspond to a dedicated block (e.g., the specific/dedicated blocks 604a-604b). The at least one second ML block (e.g., the specific/dedicated blocks 604a-604b) may be associated with a single first ML block of the at least one first ML block (e.g., the backbone/general block 602), such that the configuration of the ML model may be based on the association of the at least one second ML block with the single first ML block of the at least one first ML block. Alternatively, the at least one second ML block (e.g., the specific/dedicated blocks 604a-604b) may be associated with a plurality of first ML blocks of the at least one first ML block (e.g., the backbone/general block 602), such that the configuration of the ML model may be based on the association of the at least one second ML block with the plurality of first ML blocks of the at least one first ML block. The at least one first ML block (e.g., the backbone/general block 602) and the at least one second ML block (e.g., the specific/dedicated blocks 604a-604b) may each include one or more layers—the one or more layers may include at least one of a convolution layer, an FC layer, a pooling layer, or an activation layer. The setting, at 1304, may be performed by the setter component 1542 of the apparatus 1502 in FIG. 15.

At 1308, the base station may transmit the DCI that triggers the configuration of the ML model at the UE based on setting the one or more bits of the DCI to trigger the configuration of the ML model at the UE. For example, referring to FIGS. 6-9, the base station 904 may transmit, at 910, a DCI-based indication to the UE 902 that triggers configuration, at 914, of the combined ML model based on setting, at 908, the DCI bits to trigger the ML model configuration. The DCI that triggers, at 910/712, the configuration, at 914, of the ML model may include a first DCI domain and a second DCI domain. As indicated in the bit sequence diagrams 800-820, the first DCI domain may include a first set of bits indicative of the at least one first ML block (e.g., the backbone/general block 602) and the second DCI domain may include a second set of bits indicative of the at least one second ML block (e.g., the specific/dedicated blocks 604a-604b). In the bit sequence diagram 800, the first set of bits may be indicative of a single first ML block of the at least one first ML block (e.g., the backbone/general block 602) and the at least one second ML block (e.g., the specific/dedicated blocks 604a-604b) may be associated with the single first ML block based on the first set of bits being indicative of the single first ML block. In the bit sequence diagram 810, the first set of bits may be indicative of a plurality of first ML blocks of the at least one first ML block (e.g., the backbone/general block 602) and the at least one second ML block (e.g., the specific/dedicated blocks 604a-604b) associated with the plurality of first ML blocks may be based on the second set of bits being indicative of the association between the at least one second ML block and the plurality of first ML blocks. The DCI that triggers, at 910/712, the configuration, at 914, of the ML model may include, in a same DCI domain, a first set of bits indicative of the at least one first ML block (e.g., the backbone/general block 602) and a second set of bits indicative of the at least one second ML block (e.g., the specific/dedicated blocks 604a-604b). In the bit sequence diagram 820, the association between the at least one first ML block (e.g., the backbone/general block 602) and the at least one second ML block (e.g., the specific/dedicated blocks 604a-604b) may be based on the first set of bits and the second set of bits being included in the same DCI domain. The transmission, at 1308, may be performed by the transmission component 1534 of the apparatus 1502 in FIG. 15.

FIG. 14 is a diagram 1400 illustrating an example of a hardware implementation for an apparatus 1402. The apparatus 1402 may be a UE, a component of a UE, or may implement UE functionality. In some aspects, the apparatus 1402 may include a cellular baseband processor 1404 (also referred to as a modem) coupled to a cellular RF transceiver 1422. In some aspects, the apparatus 1402 may further include one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, or a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 350 of FIG. 3) and include the additional modules of the apparatus 1402.

The reception component 1430 is configured, e.g., as described in connection with 1002, 1102, and 1104, to receive a parameter configuration for one or more parameters of at least one second ML block—the one or more parameters include an index for associating the at least one second ML block with at least one first ML block; and to receive DCI that triggers a configuration of an ML model—the configuration of the ML model is based on an association between the at least one first ML block for a generalized procedure and the at least one second ML block for a condition of the generalized procedure. The communication manager 1432 includes an association component 1440 that is configured, e.g., as described in connection with 1106a and 1106b, to associate the at least one second ML block with a single first ML block of the at least one first ML block—the configuration of the ML model is based on the association of the at least one second ML block with the single first ML block of the at least one first ML block; and to associate the at least one second ML block with a plurality of first ML blocks of the at least one first ML block—the configuration of the ML model is based on the association of the at least one second ML block with the plurality of first ML blocks of the at least one first ML block. The communication manager 1432 further includes a configuration component 1442 that is configured, e.g., as described in connection with 1004 and 1108, to configure the ML model including the association between the at least one first ML block for the generalized procedure and the at least one second ML block for the condition of the generalized procedure based on the DCI that triggers the configuration of the ML model.

The apparatus may include additional components that perform each of the blocks of the algorithm in the flowcharts of FIGS. 10-11. As such, each block in the flowcharts of FIGS. 10-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the cellular baseband processor 1404, includes means for receiving DCI that triggers a configuration of an ML model, the configuration of the ML model based on an association between at least one first ML block for a generalized procedure and at least one second ML block for a condition of the generalized procedure; and means for configuring the ML model including the association between the at least one first ML block for the generalized procedure and the at least one second ML block for the condition of the generalized procedure based on the DCI that triggers the configuration of the ML model. The apparatus 1402 further includes means for receiving a parameter configuration for one or more parameters of the at least one second ML block, the one or more parameters including an index for associating the at least one second ML block with the at least one first ML block. The apparatus 1402 further includes means for associating the at least one second ML block with a single first ML block of the at least one first ML block, the configuration of the ML model based on the association of the at least one second ML block with the single first ML block of the at least one first ML block. The apparatus 1402 further includes means for associating the at least one second ML block with a plurality of first ML blocks of the at least one first ML block, the configuration of the ML model based on the association of the at least one second ML block with the plurality of first ML blocks of the at least one first ML block.

The means may be one or more of the components of the apparatus 1402 configured to perform the functions recited by the means. As described supra, the apparatus 1402 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 15 is a diagram 1500 illustrating an example of a hardware implementation for an apparatus 1502. The apparatus 1502 may be a base station, a component of a base station, or may implement base station functionality. In some aspects, the apparatus 1402 may include a baseband unit 1504. The baseband unit 1504 may communicate through a cellular RF transceiver 1522 with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 310 and may include the memory 376 and/or at least one of the TX processor 316, the RX processor 370, and the controller/processor 375.

The communication manager 1532 includes a configuration component 1540 that is configured, e.g., as described in connection with 1304, to configure one or more trigger states via an RRC message. The communication manager 1532 further includes a setter component 1542 that is configured, e.g., as described in connection with 1202 and 1306, to set one or more bits of DCI to trigger a configuration of an ML model at a UE—the configuration of the ML model is based on the association between the at least one first ML block for a generalized procedure and the at least one second ML block for a condition of the generalized procedure. The transmission component 1534 is configured, e.g., as described in connection with 1204, 1302, and 1308, to transmit a parameter configuration for one or more parameters of at least one second ML block—the one or more parameters include an index for an association between at least one first ML block and at least one second ML block; and to transmit the DCI that triggers the configuration of the ML model at the UE based on setting the one or more bits of the DCI to trigger the configuration of the ML model at the UE.

The apparatus may include additional components that perform each of the blocks of the algorithm in the flowcharts of FIGS. 12-13. As such, each block in the flowcharts of FIGS. 12-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the baseband unit 1504, includes means for setting one or more bits of DCI to trigger a configuration of an ML model at a UE, the configuration of the ML model based on an association between at least one first ML block for a generalized procedure and at least one second ML block for a condition of the generalized procedure; and means for transmitting the DCI that triggers the configuration of the ML model at the UE based on setting the one or more bits of the DCI to trigger the configuration of the ML model at the UE. The apparatus 1502 further includes means for transmitting a parameter configuration for one or more parameters of the at least one second ML block, the one or more parameters including an index for the association between the at least one first ML block and the at least one second ML block. The apparatus 1502 further includes means for configuring the one or more trigger states via an RRC message.

The means may be one or more of the components of the apparatus 1502 configured to perform the functions recited by the means. As described supra, the apparatus 1502 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE including receiving DCI for at least one of triggering or determining a configuration of an ML model, the configuration of the ML model based on an association between at least one first ML block for a first procedure and at least one second ML block for a second procedure, the at least one second ML block dedicated to a task included in a plurality of tasks associated with the at least one first ML block; and configuring the ML model including the association between the at least one first ML block for the first procedure and the at least one second ML block for the second procedure based on the DCI for at least one of triggering or determining the configuration of the ML model.

Aspect 2 may be combined with aspect 1 and includes that the at least one first ML block corresponds to a backbone block.

Aspect 3 may be combined with any of aspects 1-2 and includes that the at least one second ML block corresponds to a dedicated block.

Aspect 4 may be combined with any of aspects 1-3 and includes that the DCI includes a first DCI domain including a first set of bits indicative of the at least one first ML block.

Aspect 5 may be combined with any of aspects 1-4 and includes that the DCI includes a second DCI domain including a second set of bits indicative of the at least one second ML block.

Aspect 6 may be combined with any of aspects 1-5 and includes that the first set of bits is indicative of a single first ML block of the at least one first ML block.

Aspect 7 may be combined with any of aspects 1-6 and includes that the at least one second ML block is associated with the single first ML block based on the first set of bits being indicative of the single first ML block.

Aspect 8 may be combined with any of aspects 1-5 and includes that the first set of bits is indicative of a plurality of first ML blocks of the at least one first ML block.

Aspect 9 may be combined with any of aspects 1-5 and 8 and includes that the at least one second ML block is associated with the plurality of first ML blocks based on the second set of bits being indicative of the association between the at least one second ML block and the plurality of first ML blocks.

Aspect 10 may be combined with any of aspects 1-3 and includes that the DCI includes, in a same DCI domain, a first set of bits indicative of the at least one first ML block and a second set of bits indicative of the at least one second ML block.

Aspect 11 may be combined with any of aspects 1-3 and 10 and includes that the association between the at least one first ML block and the at least one second ML block is based on the first set of bits and the second set of bits being included in the same DCI domain.

Aspect 12 may be combined with any of aspects 1-3 and further includes receiving a parameter configuration for one or more parameters of the at least one second ML block.

Aspect 13 may be combined with any of aspects 1-3 and 12 and includes that the one or more parameters include an index for associating the at least one second ML block with the at least one first ML block.

Aspect 14 may be combined with any of aspects 1-3 or 13 and includes that the DCI includes a second set of bits indicative of the at least one second ML block.

Aspect 15 may be combined with any of aspects 1-9 and includes that the association between the at least one first ML block and the at least one second ML block is based on indexing the at least one second ML block to the at least one first ML block via the second set of bits.

Aspect 16 may be combined with any of aspects 1-9 and 15 and includes that the association between the at least one first ML block and the at least one second ML block is based on the parameter configuration for the one or more parameters.

Aspect 17 may be combined with any of aspects 1-16 and further includes associating the at least one second ML block with a single first ML block of the at least one first ML block.

Aspect 18 may be combined with any of aspects 1-17 and includes that the configuration of the ML model is based on the association of the at least one second ML block with the single first ML block of the at least one first ML block.

Aspect 19 may be combined with any of aspects 1-16 and further includes associating the at least one second ML block with a plurality of first ML blocks of the at least one first ML block.

Aspect 20 may be combined with any of aspects 1-16 and 19 and includes that the configuration of the ML model is based on the association of the at least one second ML block with the plurality of first ML blocks of the at least one first ML block.

Aspect 21 may be combined with any of aspects 1-3 and includes that the DCI indicates a trigger index that triggers the configuration of the ML model.

Aspect 22 may be combined with any of aspects 1-3 and 21 and includes that the trigger index is indicative of one or more trigger states that correspond to one or more associations between the at least one first ML block and the at least one second ML block.

Aspect 23 may be combined with any of aspects 1-3 or 21-22 and includes that the one or more trigger states are configured via an RRC message.

Aspect 24 may be combined with any of aspects 1-23 and includes that the at least one first ML block includes one or more layers including at least one of a convolution layer, an FC layer, a pooling layer, or an activation layer.

Aspect 25 may be combined with any of aspects 1-24 and includes that the at least one second ML block includes one or more layers including at least one of a convolution layer, an FC layer, a pooling layer, or an activation layer.

Aspect 26 may be combined with any of aspects 1-25 and further includes preforming the method based on at least one of an antenna or a transceiver.

Aspect 27 is a method of wireless communication at a base station including setting one or more bits of DCI that at least one of indicate or trigger a configuration of an ML model at a UE, the configuration of the ML model based on an association between at least one first ML block for a first procedure and at least one second ML block for a second procedure, the at least one second ML block dedicated to a task included in a plurality of tasks associated with the at least one first ML block; and transmitting the DCI that at least one of indicates or triggers the configuration of the ML model at the UE based on setting the one or more bits of the DCI.

Aspect 28 may be combined with aspect 27 and includes that the at least one first ML block corresponds to a backbone block.

Aspect 29 may be combined with any of aspects 27-28 and includes that the at least one second ML block corresponds to a dedicated block.

Aspect 30 may be combined with any of aspects 27-29 and includes that the DCI includes a first DCI domain and a second DCI domain.

Aspect 31 may be combined with any of aspects 27-30 and includes that the first DCI domain includes a first set of bits of the one or more bits indicative of the at least one first ML block.

Aspect 32 may be combined with any of aspects 27-31 and includes that the second DCI domain includes a second set of bits of the one or more bits indicative of the at least one second ML block.

Aspect 33 may be combined with any of aspects 27-32 and includes that the first set of bits is indicative of a single first ML block of the at least one first ML block.

Aspect 34 may be combined with any of aspects 27-33 and includes that the at least one second ML block is associated with the single first ML block based on the first set of bits being indicative of the single first ML block.

Aspect 35 may be combined with any of aspects 27-34 and includes that the first set of bits is indicative of a plurality of first ML blocks of the at least one first ML block.

Aspect 36 may be combined with any of aspects 27-35 and includes that the at least one second ML block is associated with the plurality of first ML blocks based on the second set of bits being indicative of the association between the at least one second ML block and the plurality of first ML blocks.

Aspect 37 may be combined with any of aspects 27-29 and includes that the DCI includes, in a same DCI domain, a first set of bits of the one or more bits indicative of the at least one first ML block.

Aspect 38 may be combined with any of aspects 27-29 and 37 and includes that the DCI includes, in a same DCI domain, a second set of bits of the one or more bits indicative of the at least one second ML block.

Aspect 39 may be combined with any of aspects 27-29 and 37-38 and includes that the association between the at least one first ML block and the at least one second ML block is based on the first set of bits and the second set of bits being included in the same DCI domain.

Aspect 40 may be combined with any of aspects 27-29 and further includes transmitting a parameter configuration for one or more parameters of the at least one second ML block.

Aspect 41 may be combined with any of aspect 27-29 and 40 and includes that the one or more parameters include an index for the association between the at least one first ML block and the at least one second ML block.

Aspect 42 may be combined with any of aspects 27-29 and 40-41 and includes that the DCI includes a second set of bits of the one or more bits indicative of the at least one second ML block.

Aspect 43 may be combined with any of aspect 27-29 and 40-42 and includes that the association between the at least one first ML block and the at least one second ML block is based on indexing the at least one second ML block to the at least one first ML block via the second set of bits.

Aspect 44 may be combined with any of aspect 27-29 and 40-43 and includes that the association between the at least one first ML block and the at least one second ML block is based on the parameter configuration for the one or more parameters.

Aspect 45 may be combined with any of aspects 27-44 and includes that the at least one second ML block is associated with a single first ML block of the at least one first ML block.

Aspect 46 may be combined with any of aspects 27-45 and includes that the configuration of the ML model is based on the association of the at least one second ML block with the single first ML block of the at least one first ML block.

Aspect 47 may be combined with any of aspects 27-44 and includes that the at least one second ML block is associated with a plurality of first ML blocks of the at least one first ML block.

Aspect 48 may be combined with any of aspects 27-44 and 47 and includes that the configuration of the ML model is based on the association of the at least one second ML block with the plurality of first ML blocks of the at least one first ML block.

Aspect 49 may be combined with any of aspects 27-29 and includes that the DCI indicates a trigger index that triggers the configuration of the ML model at the UE.

Aspect 50 may be combined with any of aspects 27-29 and 49 and includes that the trigger index is indicative of one or more trigger states that correspond to one or more associations between the at least one first ML block and the at least one second ML block.

Aspect 51 may be combined with any of aspects 27-29 and 49-50 and further includes configuring the one or more trigger states via an RRC message.

Aspect 52 may be combined with any of aspects 27-51 and includes that the at least one first ML block includes one or more layers including at least one of a convolution layer, an FC layer, a pooling layer, or an activation layer.

Aspect 53 may be combined with any of aspects 27-52 and includes that the at least one second ML block includes one or more layers including at least one of a convolution layer, an FC layer, a pooling layer, or an activation layer.

Aspect 54 may be combined with any of aspects 27-53 and further includes performing the method based on at least one of an antenna or a transceiver.

Aspect 55 is an apparatus for wireless communication at a UE configured to perform the method of any of aspects 1-26.

Aspect 56 is an apparatus for wireless communication including means for performing the method of any of aspects 1-26.

Aspect 57 is a non-transitory computer-readable storage medium storing computer executable code, the code when executed by at least one processor causes the at least one processor to perform the method of any of aspects 1-26.

Aspect 58 is an apparatus for wireless communication at a UE configured to perform the method of any of aspects 27-54.

Aspect 59 is an apparatus for wireless communication including means for performing the method of any of aspects 27-54.

Aspect 60 is a non-transitory computer-readable storage medium storing computer executable code, the code when executed by at least one processor causes the at least one processor to perform the method of any of aspects 27-54.

What is claimed is:

1. An apparatus for wireless communication at a user equipment (UE), comprising:
a memory; and
at least one processor coupled to the memory, the memory and the at least one processor configured to:
receive downlink control information (DCI) for at least one of triggering or determining a configuration of a machine learning (ML) model, the configuration of the ML model based on an association between at least one first ML block for a first procedure and at least one second ML block for a second procedure, the at least one second ML block dedicated to a task included in a plurality of tasks associated with the at least one first ML block; and
configure the ML model including the association between the at least one first ML block for the first procedure and the at least one second ML block for the second procedure based on the DCI for at least one of triggering or determining the configuration of the ML model.

2. The apparatus of claim 1, wherein the at least one first ML block corresponds to a backbone block and the at least one second ML block corresponds to a dedicated block.

3. The apparatus of claim 1, wherein the DCI includes a first DCI domain and a second DCI domain, the first DCI domain including a first set of bits indicative of the at least one first ML block, the second DCI domain including a second set of bits indicative of the at least one second ML block.

4. The apparatus of claim 3, wherein the first set of bits is indicative of a single first ML block of the at least one first ML block, the at least one second ML block associated with the single first ML block based on the first set of bits being indicative of the single first ML block.

5. The apparatus of claim 3, wherein the first set of bits is indicative of a plurality of first ML blocks of the at least one first ML block, the at least one second ML block associated with the plurality of first ML blocks based on the second set of bits being indicative of the association between the at least one second ML block and the plurality of first ML blocks.

6. The apparatus of claim 1, wherein the DCI includes, in a same DCI domain, a first set of bits indicative of the at least one first ML block and a second set of bits indicative of the at least one second ML block, the association between the at least one first ML block and the at least one second ML block based on the first set of bits and the second set of bits being included in the same DCI domain.

7. The apparatus of claim 1, wherein the memory and the at least one processor are further configured to receive a parameter configuration for one or more parameters of the at least one second ML block, the one or more parameters including an index for associating the at least one second ML block with the at least one first ML block.

8. The apparatus of claim 7, wherein the DCI includes a second set of bits indicative of the at least one second ML block, the association between the at least one first ML block and the at least one second ML block based on indexing the at least one second ML block to the at least one first ML block via the second set of bits and the parameter configuration for the one or more parameters.

9. The apparatus of claim 1, wherein the memory and the at least one processor are further configured to associate the at least one second ML block with a single first ML block of the at least one first ML block, the configuration of the ML model based on the association of the at least one second ML block with the single first ML block of the at least one first ML block.

10. The apparatus of claim 1, wherein the memory and the at least one processor are further configured to associate the at least one second ML block with a plurality of first ML blocks of the at least one first ML block, the configuration of the ML model based on the association of the at least one second ML block with the plurality of first ML blocks of the at least one first ML block.

11. The apparatus of claim 1, wherein the DCI indicates a trigger index that triggers the configuration of the ML model, the trigger index indicative of one or more trigger states that correspond to one or more associations between the at least one first ML block and the at least one second ML block.

12. The apparatus of claim 11, wherein the one or more trigger states are configured via a radio resource control (RRC) message.

13. The apparatus of claim 1, wherein the at least one first ML block and the at least one second ML block each include one or more layers, the one or more layers including at least one of a convolution layer, a fully connected (FC) layer, a pooling layer, or an activation layer.

14. An apparatus for wireless communication at a base station, comprising:
a memory; and
at least one processor coupled to the memory, the memory and the at least one processor configured to:
set one or more bits of downlink control information (DCI) that at least one of indicate or trigger a configuration of a machine learning (ML) model at a user equipment (UE), the configuration of the ML model based on an association between at least one first ML block for a first procedure and at least one second ML block for a second procedure, the at least one second ML block dedicated to a task included in a plurality of tasks associated with the at least one first ML block; and
transmit the DCI that at least one of indicates or triggers the configuration of the ML model at the UE based on setting the one or more bits of the DCI.

15. The apparatus of claim 14, wherein the at least one first ML block corresponds to a backbone block and the at least one second ML block corresponds to a dedicated block.

16. The apparatus of claim 14, wherein the DCI includes a first DCI domain and a second DCI domain, the first DCI domain including a first set of bits of the one or more bits indicative of the at least one first ML block, the second DCI domain including a second set of bits of the one or more bits indicative of the at least one second ML block.

17. The apparatus of claim 16, wherein the first set of bits is indicative of a single first ML block of the at least one first ML block, the at least one second ML block associated with the single first ML block based on the first set of bits being indicative of the single first ML block.

18. The apparatus of claim 16, wherein the first set of bits is indicative of a plurality of first ML blocks of the at least one first ML block, the at least one second ML block associated with the plurality of first ML blocks based on the second set of bits being indicative of the association between the at least one second ML block and the plurality of first ML blocks.

19. The apparatus of claim 14, wherein the DCI includes, in a same DCI domain, a first set of bits of the one or more bits indicative of the at least one first ML block and a second set of bits of the one or more bits indicative of the at least one second ML block, the association between the at least one first ML block and the at least one second ML block based on the first set of bits and the second set of bits being included in the same DCI domain.

20. The apparatus of claim 14, wherein the memory and the at least one processor are further configured to transmit a parameter configuration for one or more parameters of the at least one second ML block, the one or more parameters including an index for the association between the at least one first ML block and the at least one second ML block.

21. The apparatus of claim 20, wherein the DCI includes a second set of bits of the one or more bits indicative of the at least one second ML block, the association between the at least one first ML block and the at least one second ML block based on indexing the at least one second ML block to the at least one first ML block via the second set of bits and the parameter configuration for the one or more parameters.

22. The apparatus of claim 14, wherein the at least one second ML block is associated with a single first ML block of the at least one first ML block, the configuration of the ML model based on the association of the at least one second ML block with the single first ML block of the at least one first ML block.

23. The apparatus of claim 14, wherein the at least one second ML block is associated with a plurality of first ML blocks of the at least one first ML block, the configuration of the ML model based on the association of the at least one second ML block with the plurality of first ML blocks of the at least one first ML block.

24. The apparatus of claim 14, wherein the DCI indicates a trigger index that triggers the configuration of the ML model at the UE, the trigger index indicative of one or more trigger states that correspond to one or more associations between the at least one first ML block and the at least one second ML block.

25. The apparatus of claim 24, wherein the memory and the at least one processor are further configured to configure the one or more trigger states via a radio resource control (RRC) message.

26. The apparatus of claim 14, wherein the at least one first ML block and the at least one second ML block each include one or more layers, the one or more layers including at least one of a convolution layer, a fully connected (FC) layer, a pooling layer, or an activation layer.

27. A method of wireless communication at a user equipment (UE), comprising:
receiving downlink control information (DCI) for at least one of triggering or determining a configuration of a machine learning (ML) model, the configuration of the ML model based on an association between at least one first ML block for a first procedure and at least one second ML block for a second procedure, the at least one second ML block dedicated to a task included in a plurality of tasks associated with the at least one first ML block; and
configuring the ML model including the association between the at least one first ML block for the first procedure and the at least one second ML block for the second procedure based on the DCI for at least one of triggering or determining the configuration of the ML model.

28. The method of claim 27, wherein the at least one first ML block corresponds to a backbone block and the at least one second ML block corresponds to a dedicated block.

29. A method of wireless communication at a base station, comprising:
setting one or more bits of downlink control information (DCI) that at least one of indicate or trigger a configuration of a machine learning (ML) model at a user equipment (UE), the configuration of the ML model based on an association between at least one first ML block for a first procedure and at least one second ML block for a second procedure, the at least one second ML block dedicated to a task included in a plurality of tasks associated with the at least one first ML block; and
transmitting the DCI that at least one of indicates or triggers the configuration of the ML model at the UE based on setting the one or more bits of the DCI.

30. The method of claim 29, wherein the at least one first ML block corresponds to a backbone block and the at least one second ML block corresponds to a dedicated block.
